(19) United States
(12) Patent Application Publication
(10) Pub. No.: US 2026/0180443 A1
(43) Pub. Date: Jun. 25, 2026

(54) MULTI-PHASE SWITCHING VOLTAGE REGULATOR AND CONTROLLER

(71) Applicant: Infineon Technologies Austria AG, Villach (AT)

(72) Inventor: Venkat Sreenivas, Winchester, MA (US)

(21) Appl. No.: 18/989,350

(22) Filed: Dec. 20, 2024

(51) Int. Cl. H02M 3/158; H02M 1/00

(52) U.S. Cl. CPC H02M 3/158; H02M 1/0012

(57) ABSTRACT

A controller for a multi-phase switching voltage regulator includes a first control loop and a second control loop. The first control loop has a first set of coefficients for implementing pulse width modulation (PWM) and a second set of coefficients for implementing pulse frequency modulation (PFM). The second control loop is configured to implement phase current balancing for the multi-phase switching voltage regulator. In a first configuration, the first control loop is configured to implement PWM-based control of the multi-phase switching voltage regulator using the first set of coefficients. In a second configuration, the first control loop is configured to implement PFM-based control of the multi-phase switching voltage regulator using the second set of coefficients.

### BACKGROUND

Different kinds of modulation are often required of voltage regulators. The dominant modulation schemes used by voltage regulators are PWM (pulse width modulation) and PFM (pulse frequency modulation). Conventional voltage regulators are typically designed to implement one of PWM or PFM but not both and therefore cannot switch from one modulation scheme to another modulation scheme, e.g., when adding or dropping phases.

Therefore, there is a need for a more flexible voltage regulator design that can support more than one modulation scheme.

### SUMMARY

According to an embodiment of a controller for a multi-phase switching voltage regulator, the controller comprises: a first control loop having a first set of coefficients for implementing pulse width modulation (PWM) and a second set of coefficients for implementing pulse frequency modulation (PFM); and a second control loop configured to implement phase current balancing for the multi-phase switching voltage regulator, wherein in a first configuration, the first control loop is configured to implement PWM-based control of the multi-phase switching voltage regulator using the first set of coefficients, wherein in a second configuration, the first control loop is configured to implement PFM-based control of the multi-phase switching voltage regulator using the second set of coefficients.

According to an embodiment of a voltage regulator system, the voltage regulator system comprises: a multi-phase switching voltage regulator; and a controller configured to control the multi-phase switching voltage regulator. The controller comprises: a first control loop having a first set of coefficients for implementing pulse width modulation (PWM) and a second set of coefficients for implementing pulse frequency modulation (PFM); and a second control loop configured to implement phase current balancing for the multi-phase switching voltage regulator, wherein in a first configuration, the first control loop is configured to implement PWM-based control of the multi-phase switching voltage regulator using the first set of coefficients, wherein in a second configuration, the first control loop is configured to implement PFM-based control of the multi-phase switching voltage regulator using the second set of coefficients.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a schematic diagram of a voltage regulator system that includes a multi-phase switching voltage regulator and a controller for controlling the multi-phase switching voltage regulator.

FIG. 2 illustrates different pulse width signalling techniques for constant frequency (variable pulse width) modulation.

FIG. 3 illustrates different pulse width signalling techniques for constant on-time (variable frequency) modulation.

FIGS. 4 through 10 illustrate embodiments of the first and second control loops included in the controller of the voltage regulator system.

### DETAILED DESCRIPTION

Embodiments described herein provide a controller for a multi-phase switching voltage regulator. The controller includes a first control loop and a second control loop. The second control loop implements phase current balancing for the multi-phase switching voltage regulator. The first control loop supports different modulation schemes. For example, the first control loop may have a first set of coefficients for implementing pulse width modulation (PWM) and a second set of coefficients for implementing pulse frequency modulation (PFM). In a first (constant frequency) configuration, the first control loop implements PWM-based control of the multi-phase switching voltage regulator using the first set of coefficients. In a second (constant on-time) configuration, the first control loop implements PFM-based control of the multi-phase switching voltage regulator using the second set of coefficients. This enables the multi-phase switching voltage regulator to be programmed to operate either as a pulse width modulator or a pulse frequency modulator, including in operation (in use), e.g., when changing phase count. The same gates/circuitry of the controller may be used to support both constant frequency modulation and constant on-time modulation, providing a low cost, programmable and flexible modulation approach.

Described next with reference to the figures are embodiments of the controller and the multi-phase switching voltage regulator.

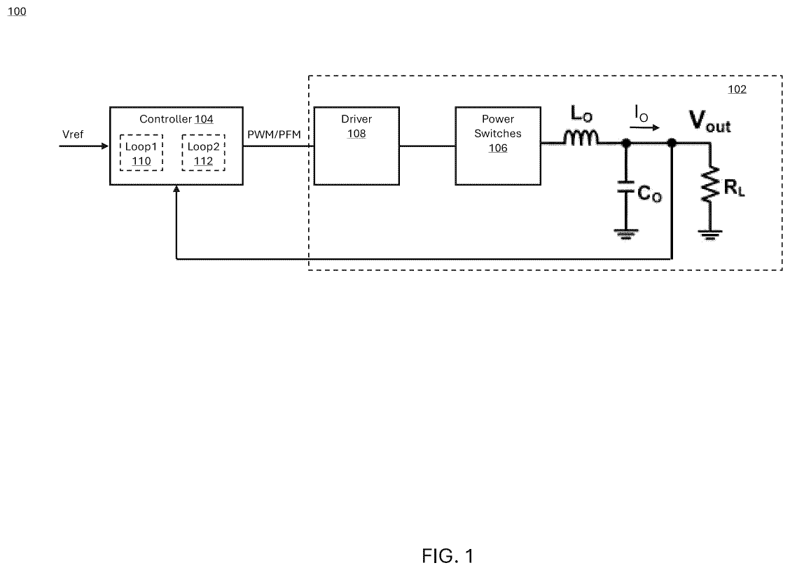

FIG. 1 illustrates a schematic diagram of a voltage regulator system 100. The voltage regulator system 100 includes a multi-phase switching voltage regulator 102 and a controller 104 that controls the multi-phase switching voltage regulator 102, by regulating the output voltage Vout of the regulator 102 based on a reference voltage Vref. The multi-phase switching voltage regulator 102 includes power switches 106 such as Si or SiC power MOSFETs (metal-oxide-semiconductor field-effect transistors), HEMTs (high-electron mobility transistors), IGBTs (insulated-gate bipolar transistors), JFETs (junction filed-effect transistors), etc. The power switches 106 are driven by a gate driver 108, under control of the controller 104.

The switching voltage regulator 102 is multi-phase in that the power switches 106 are coupled to form individual phases, each phase contributing part of the overall current I_{O} delivered to the load which is schematically illustrated as a resistor R_{L} in FIG. 1. At higher load conditions, most or all of the phases are operational. The controller 104 may drop (shed) one or more phases as load current demand drops, e.g., with a single phase being operational at the lightest load condition.

The multi-phase switching voltage regulator 102 is shown configured for buck operation in FIG. 1, with an inductor L_{O} in combination with a capacitor C_{O} to reduce voltage ripple on the output voltage Vout. The multi-phase switching voltage regulator 102 may have other configurations, such as buck-boost, boost, etc.

The controller 104 for the multi-phase switching voltage regulator 102 includes a first control loop 110 having a first set of coefficients for implementing pulse width modulation (PWM) and a second set of coefficients for implementing pulse frequency modulation (PFM). The controller 104 also includes a second control loop 112 that implements phase current balancing (current sharing) for the multi-phase switching voltage regulator 102. For example, the second control loop 112 may adjust the pulse width or frequency of each phase based on the sensed average phase current, to equalize the current in each phase. Other current balance techniques may be implemented by the second control loop 112.

In a first (constant frequency) configuration, the first control loop 110 implements PWM-based control of the multi-phase switching voltage regulator 102 using the first set of coefficients. In a second (constant on-time) configuration, the first control loop 110 implements PFM-based control of the multi-phase switching voltage regulator 102 using the second set of coefficients. The first control loop 110 may be a voltage and/or current mode control loop that implements PWM or PFM, depending on the configuration. The configuration may be fixed during operation of the multi-phase switching voltage regulator 102. Alternatively, the first control loop 110 may be programmable in either the first configuration or the second configuration during operation of the multi-phase switching voltage regulator 102. In each case, the controller 104 supports both constant frequency modulation and constant on-time modulation using the same control loop 110.

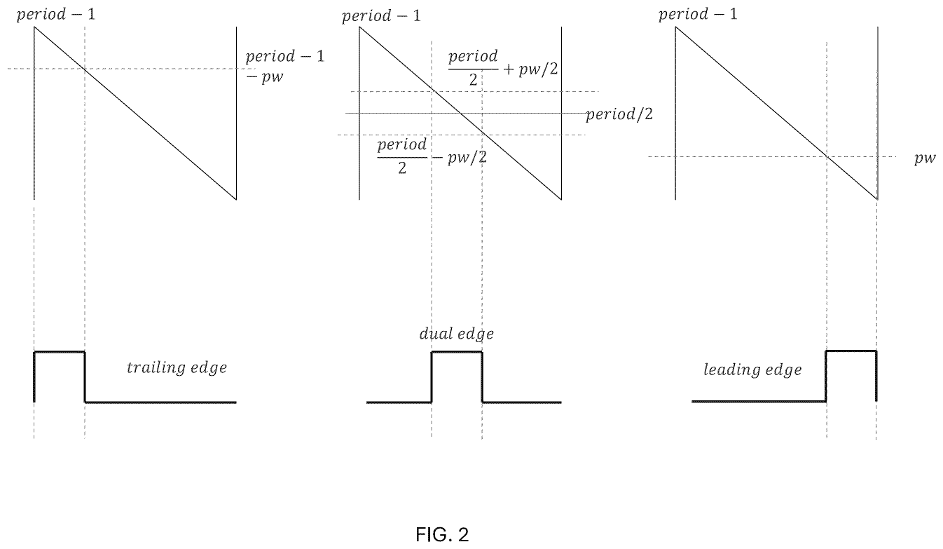

FIG. 2 illustrates different pulse width signalling techniques for constant frequency (variable pulse width) modulation, which can be implemented by the controller 104 for the multi-phase switching voltage regulator 102. With constant frequency modulation, the switching frequency and thus switching period is fixed and the width of the modulation pulse ‘pw’ is varied to achieve modulation. The modulation pulse may be trailing edge, leading edge, or dual edge, as shown in FIG. 2.

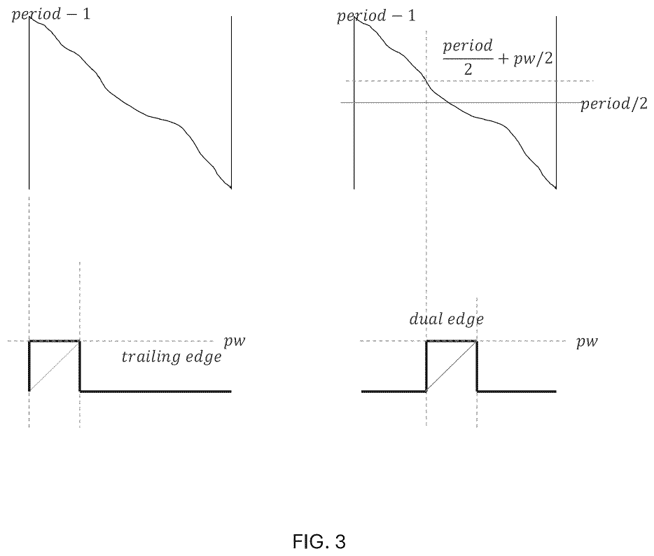

FIG. 3 illustrates different pulse width signalling techniques for constant on-time (variable frequency) modulation, which can be implemented by the controller 104 for the multi-phase switching voltage regulator 102. With constant on-time modulation, the width of the modulation pulse ‘pw’ is fixed and the switching frequency Fsw is varied to achieve modulation. The modulation pulse may be trailing edge or dual edge, as shown in FIG. 3.

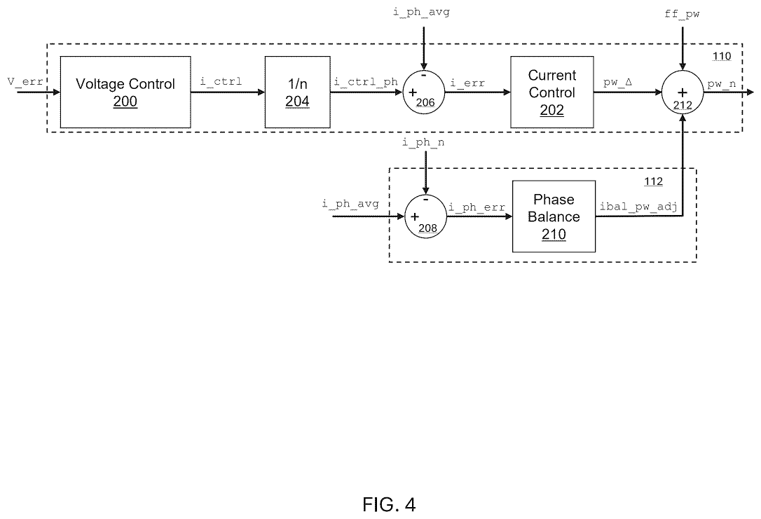

FIGS. 4 through 10 illustrate embodiments of the first and second control loops 110, 112 included in the controller 104. Some embodiments use both voltage and current mode control, whereas other embodiments use voltage mode control but not current mode control.

In FIG. 4, the first control loop 110 of the controller 104 includes both a voltage mode controller 200 and a current mode controller 202 and the first control loop 110 is shown configured in the first (constant frequency) configuration. The voltage mode controller 200, which may be, e.g., a PID (proportional-integral-derivative) controller with poles, generates a current control signal i_ctrl based on a voltage error signal V_err that represents the difference between the reference voltage Vref and the output voltage of Vout the multi-phase switching voltage regulator 102. In the first configuration, the current mode controller 202 uses the first set of coefficients to generate a pulse width modulation adjustment signal pw_Δ based on a current error signal i_err derived from the current control signal i_ctrl.

In FIG. 4, the first control loop 110 includes logic/circuitry 204 that divides the current control signal i_ctrl by the number of active phases ‘n’ of the multi-phase switching voltage regulator 102 to generate a per-phase current control signal i_ctrl_ph. The first control loop 110 also includes logic/circuitry 206 that compares the per-phase current control signal i_ctrl_ph to a signal i_ph_avg that represents the average current of all the active phases of the multi-phase switching voltage regulator 102, to generate the current error signal i_err.

The second control loop 112 includes logic/circuitry 208 that compares the individual phase currents i_ph_n to the signal i_ph_avg that represents the average current of all the active phases, to generate a per-phase current error i_ph_err. The second control loop 112 also includes current balancing logic/circuitry 210 that generates a current balance adjustment signal ibal_pw_adj for each active phase of the multi-phase switching voltage regulator 102, to balance the phase currents. According to this embodiment, the current control function is split into two comparisons: one for phase control current to average current and the other for average current to phase currents. This approach requires only a single current control block 202 for the first control loop 110, which is a faster block. The phase balance blocks 208, 210 can be slower. Even though n phase balance modules 210 are used in this embodiment, logic gates/circuitry can be saved by reducing resolution and/or by time sharing (time division multiplexing) the logic.

If the controller 104 employs feedforward control, the first control loop 110 may include logic/circuitry 212 that modifies a feedforward pulse width modulation signal ff_pw with the pulse width modulation adjustment signal pw_Δ and the current balance adjustment signal ibal_pw_adj generated by the second control loop 112 for each active phase of the multi-phase switching voltage regulator 102, to generate a pulse width modulation signal pw_n for controlling each active phase of the multi-phase switching voltage regulator 102 in the first configuration. For example, the feedforward pulse width modulation signal ff_pw may be a pulse signal and the pulse width modulation adjustment signal pw_Δ and the current balance adjustment signal ibal_pw_adj determine how much the width of the pulse signal is adjusted to maintain regulation.

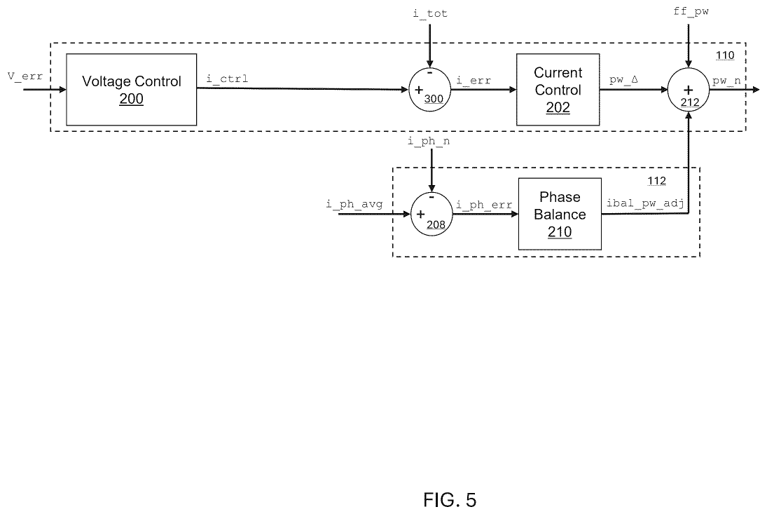

In FIG. 5, the first control loop 110 is again shown configured in the first (constant frequency) configuration. Different than in FIG. 4, the first control loop 110 in FIG. 5 includes logic/circuitry 300 that compares the current control signal i_ctrl to a signal i_tot that represents the total current of all active phases of the multi-phase switching voltage regulator 102, to generate the current error signal i_err. According to this embodiment, the first control loop 110 omits the divide-by-n block 204 shown in FIG. 4, which simplifies the control loop logic and reduces latency in the fast path through the current mode controller 202. The gains inside the current mode controller 202 changes as the number n of active phases changes.

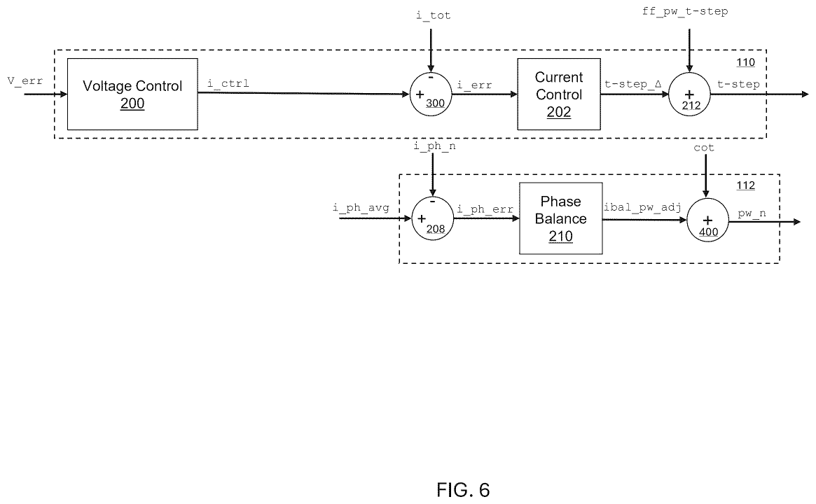

In FIG. 6, the first control loop 110 is shown configured in the second (constant on-time) configuration. By comparing FIGS. 4 and 5 with FIG. 6, it can be seen that the controller 104 does not require different gates/circuitry to support both constant frequency modulation and constant on-time modulation. Instead, the same voltage mode controller 200 and current mode controller 202 may be used to support both the first and second modulation configurations.

In the second (constant on-time) configuration, the current mode controller 202 uses the second set of coefficients to generate a pulse frequency modulation adjustment signal t-step_Δ based on the current error signal i_err. If the controller 104 employs feedforward control, the first control loop 110 may include logic/circuitry 212 that modifies a feedforward pulse frequency modulation signal ff_pw_t-step with the pulse frequency modulation adjustment signal t-step_Δ, to generate a pulse frequency modulation signal t-step for controlling each active phase of the multi-phase switching voltage regulator 102. The second control loop 112 may also include logic/circuitry 400 that modifies a constant on-time ‘cot’ for each active phase of the multi-phase switching voltage regulator 102 based on the phase current imbalance ibal_pw_adj observed by the current balancing logic/circuitry 210 of the second control loop 112, to generate the pulse width modulation signal pw_n.

By interpreting the output of the current control block 202 as a time step delta (t-step_Δ in FIG. 6) instead of a pulse width delta (pw_Δ in FIGS. 4 and 5) and by using the width of the feedforward pulse frequency modulation signal ff_pw_t-step as the constant on time signal cot, the control structure shown in FIG. 5 can be used to implement constant on time modulation. Since the control structure is the same in FIGS. 5 and 6, modulation configurability (constant frequency or constant on-time) can be supported without a large gate count penalty. The gain in the current mode controller 202 may change but the control structure and corresponding math remains the same.

Constant frequency and constant on-time modulation can be related, mathematically, as follows:

$$\begin{matrix}dutyc = \frac{F F + p w d}{T} = ON\_t ( r + r d ) & \\ = \frac{F F}{T} ( 1 + \frac{p w d}{F F} ) = ON\_t . r ( 1 + \frac{r d}{r} ) & ( 2 )\end{matrix} \qquad ( 1 )$$

where dutyc is the duty cycle in a constant switching frequency system, T is switching period, FF is the feedforward pulse width, pwd is the pulse width delta pw_Δ, r is the rate or time step t-step, rd is the time step delta t-step_Δ, and ON_t is a nominal rate plus the delta change (e.g., how the time step changes from a normal time step of one). The ratio of pwd to FF is equivalent to the ratio of rd to r and FF/T or ON_t.r is the nominal duty cycle.

As shown in equations (1) and (2), a change in time step changes the ramp rate. For a switching frequency Fsw of 1000 clock cycles, the controller 104 may start at 999 and count down to zero and repeat the process to generate a series of saw tooth ramp signals, e.g., as shown in FIG. 2. Each saw tooth ramp signal corresponds to one (1) switching period, where a new pulse starts at each zero each time. Under constant on-time modulation, the ramp may not uniformly change one step at a time from 999 to 0 but instead the controller 104 may dynamically change the step (i.e., ramp rate). For example, if a large error occurs, the controller 104 may implement a larger step (e.g., 3 steps at a time), making the ramp steeper and the period smaller with larger switching frequency Fsw. Because the time step constantly changes with constant on-time modulation, the ultimate switching frequency Fsw changes to give duty cycle variation, e.g., as shown in FIG. 3.

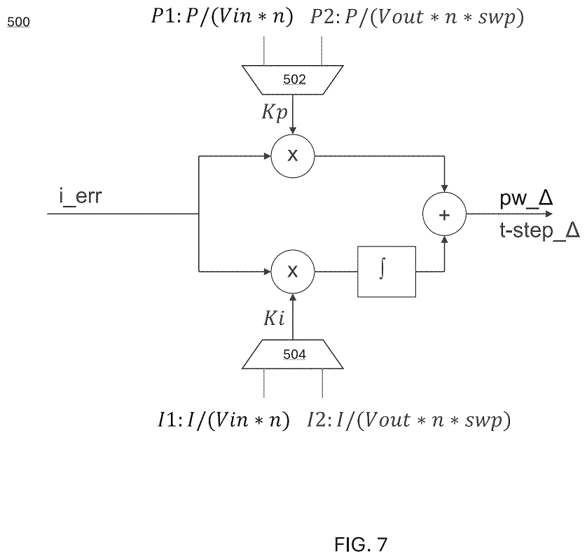

FIG. 7 illustrates a block diagram of the current mode controller 202 shown in FIGS. 4 through 6. The current mode controller 202 is a PI (proportional-integral) controller 500 in FIG. 7. According to this embodiment, the first set of coefficients includes a first proportional coefficient P1 for a proportional term Kp of the PI controller 500 and a first integral coefficient 11 for an integral term Ki of the PI controller 500. The second set of coefficients includes a second proportional coefficient P2 for the proportional term Kp and a second integral coefficient 12 for the integral term Ki.

In the first (constant frequency) configuration, the PI controller 500 uses the first set of proportional and integral coefficients P1, 11 to generate the pulse width modulation adjustment signal pw_Δ based on the current error signal i_err. In the second (constant on-time) configuration, the PI controller 500 uses the second set of proportional and integral coefficients P2, 12 to generate the pulse frequency modulation adjustment signal t-step_Δ based on the current error signal i_err. For example, the PI controller 500 may include a first multiplexor logic/gate 502 for selecting between the first and second proportional coefficients P1, P2 as the proportional term Kp of the PI controller 500 and a second multiplexor logic/gate 504 for selecting between the first and second integral coefficients 11, 12 as the integral term Ki of the PI controller 500.

In one embodiment, the first proportional coefficient P1 is calculated as P/(Vin*n), the first integral coefficient 11 is calculated as I/(Vin*n), the second proportional coefficient P2 is calculated as P/(Vout*n*swp), and the second integral coefficient 12 is calculated as I/(Vout*n*swp), where n is the number of active phases of the multi-phase switching voltage regulator 102, Vin is an input voltage of the multi-phase switching voltage regulator 102, Vout is the output voltage of the multi-phase switching voltage regulator 102, swp is the number of clocks in a switching period T, P is a programmed proportional term, and I is a programmed integral term.

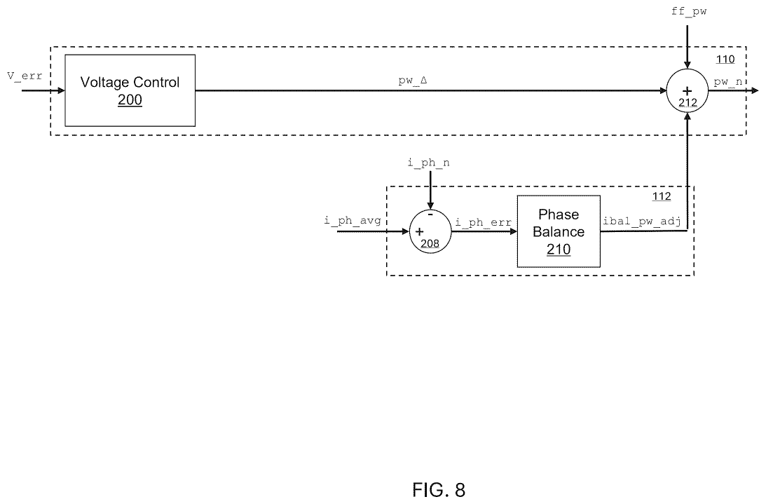

FIG. 8 illustrates the first control loop 110 configured in the first (constant frequency) configuration with voltage mode control only. That is, the first control loop 110 includes the voltage mode controller 200 but the current mode controller 202 is omitted in FIG. 8. In the first (constant frequency) configuration, the voltage mode controller 200 uses a first set of coefficients to generate the pulse width modulation adjustment signal pw_Δ based on the voltage error signal Verr, which represents the difference between the reference voltage Vref and the output voltage Vout of the multi-phase switching voltage regulator 102. The first control loop 110 may also include logic/circuitry 212 that modifies a feedforward pulse width modulation signal ff_pw with the pulse width modulation adjustment signal pw_Δ and the current balance adjustment signal ibal_pw_adj generated by the second control loop 112 for each active phase of the multi-phase switching voltage regulator 102, to generate the pulse width modulation signal pw_n for controlling each active phase of the multi-phase switching voltage regulator 102 in the first configuration.

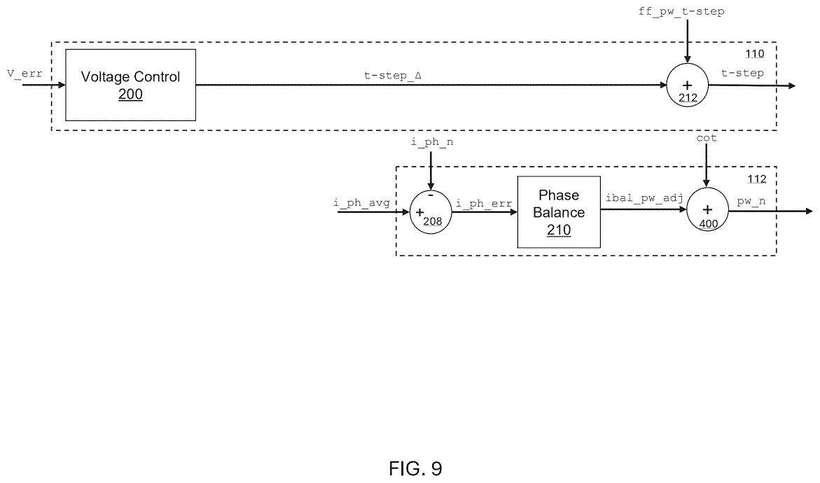

FIG. 9 illustrates the first control loop 110 of FIG. 8 but configured in the second (constant on-time) configuration. That is, the first control loop 110 includes the voltage mode controller 200 but the current mode controller 202 is omitted in FIG. 9. In the second configuration, the voltage mode controller 200 uses a second set of coefficients to generate the pulse frequency modulation adjustment signal t-step_Δ based on the voltage error signal V_err. In the second configuration, the first control loop 110 may modify the feedforward pulse frequency modulation signal ff_pw_t-step with the pulse frequency modulation adjustment signal t-step_Δ to generate the pulse frequency modulation signal t-step for controlling each active phase of the multi-phase switching voltage regulator 102. In the second configuration, the second control loop 112 may modify a constant on-time ‘cot’ for each active phase of the multi-phase switching voltage regulator 102 based on the phase current imbalance ibal_pw_adj observed by the current balancing logic/circuitry 210 of the second control loop 112.

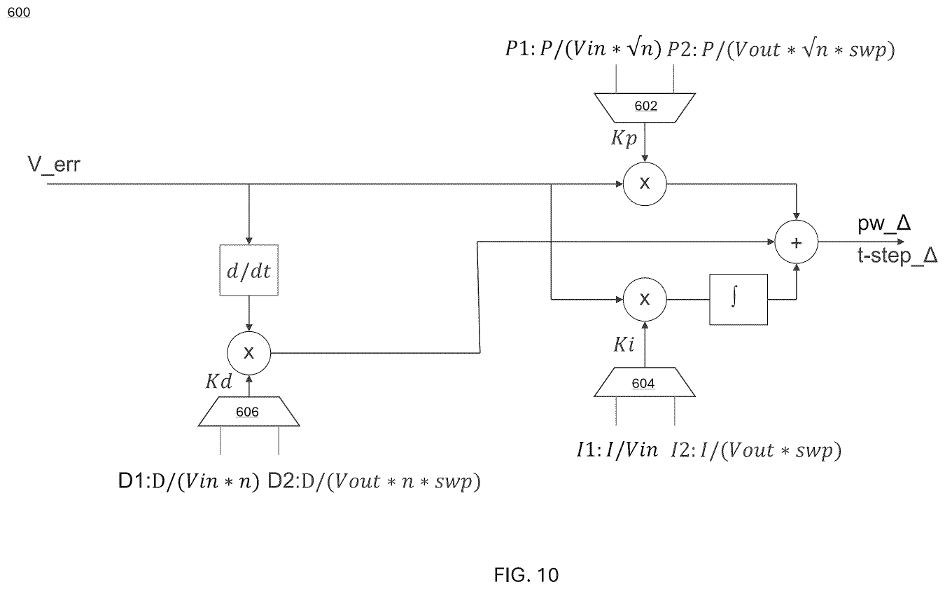

FIG. 10 illustrates a block diagram of the voltage mode controller 200 shown in FIGS. 8 and 9. The voltage mode controller 200 is a PID (proportional-integral-derivative) controller 600 in FIG. 10. According to this embodiment, the first set of coefficients comprises a first proportional coefficient P1 for a proportional term Kp of the PID controller 600, a first integral coefficient 11 for an integral term Ki of the PID controller 600, and a first derivative coefficient D1 for a derivative term Kd of the PID controller 600. The second set of coefficients includes a second proportional coefficient P2 for the proportional term Kd, a second integral coefficient 12 for the integral term Ki, and a second derivative coefficient D2 for the derivative term Kd.

In the first (constant frequency) configuration, the PID controller 600 uses the first set of proportional, integral, and derivative coefficients P1, 11, D1 to generate the pulse width modulation adjustment signal pw_Δ based on the voltage error signal V_err. In the second (constant on-time) configuration, the PID controller 600 uses the second set of proportional, integral, and derivative coefficients P2, 12, D2 to generate the pulse frequency modulation adjustment signal t-step_Δ based on the voltage error signal V_err. For example, the PID controller 600 may include a first multiplexor logic/gate 602 for selecting between the first and second proportional coefficients P1, P2 as the proportional term Kp of the PID controller 600, a second multiplexor logic/gate 604 for selecting between the first and second integral coefficients 11, 12 as the integral term Ki of the PID controller 600, and a third multiplexor logic/gate 606 for selecting between the first and second derivative coefficients D1, D2 as the derivative term Kd of the PID controller 600.

In one embodiment, the first proportional coefficient P1 is calculated as P/(Vin*\sqrt{n}), the first integral coefficient 11 is calculated as I/Vin, the first derivative coefficient D1 is calculated as D/(Vin*n), the second proportional coefficient P2 is calculated as P/(Vout*\sqrt{n}*swp), the second integral coefficient 12 is calculated as I/(Vout*swp), and the second derivative coefficient D2 is calculated as D/(Vout*n*swp), where n is the number of active phases of the multi-phase switching voltage regulator 102, Vin is the input voltage of the multi-phase switching voltage regulator 102, Vout is the output voltage of the multi-phase switching voltage regulator 102, swp is the number of clocks in a switching period T, P is a programmed proportional term, I is a programmed integral term, and D is a programmed derivative term.

Although the present disclosure is not so limited, the following numbered examples demonstrate one or more aspects of the disclosure.

Example 1. A controller for a multi-phase switching voltage regulator, the controller comprising: a first control loop having a first set of coefficients for implementing pulse width modulation (PWM) and a second set of coefficients for implementing pulse frequency modulation (PFM); and a second control loop configured to implement phase current balancing for the multi-phase switching voltage regulator, wherein in a first configuration, the first control loop is configured to implement PWM-based control of the multi-phase switching voltage regulator using the first set of coefficients, wherein in a second configuration, the first control loop is configured to implement PFM-based control of the multi-phase switching voltage regulator using the second set of coefficients.

Example 2. The controller of example 1, wherein the first control loop is programmable in either the first configuration or the second configuration during operation of the multi-phase switching voltage regulator.

Example 3. The controller of example 1 or 2, wherein the first control loop comprises: a voltage mode controller configured to generate a current control signal based on a voltage error signal that represents a difference between a reference voltage and an output voltage of the multi-phase switching voltage regulator; and a current mode controller, wherein in the first configuration, the current mode controller is configured to use the first set of coefficients to generate a pulse width modulation adjustment signal based on a current error signal derived from the current control signal, wherein in the second configuration, the current mode controller is configured to use the second set of coefficients to generate a pulse frequency modulation adjustment signal based on the current error signal.

Example 4. The controller of example 3, wherein in the first configuration, the first control loop is configured to modify a feedforward pulse width modulation signal with the pulse width modulation adjustment signal and a current balance adjustment signal generated by the second control loop for each active phase of the multi-phase switching voltage regulator to generate a pulse width modulation signal for controlling each active phase of the multi-phase switching voltage regulator.

Example 5. The controller of example 3 or 4, wherein in the second configuration, the first control loop is configured to modify a feedforward pulse frequency modulation signal with the pulse frequency modulation adjustment signal to generate a pulse frequency modulation signal for controlling each active phase of the multi-phase switching voltage regulator.

Example 6. The controller of example 5, wherein in the second configuration, the second control loop is configured to modify a constant on-time for each active phase of the multi-phase switching voltage regulator based on phase current imbalance observed by the second control loop.

Example 7. The controller of any of examples 3 through 6, wherein the first control loop is configured to divide the current control signal by a number of active phases of the multi-phase switching voltage regulator to generate a per-phase current control signal, and compare the per-phase current control signal to a signal that represents an average current of all the active phases to generate the current error signal.

Example 8. The controller of any of examples 3 through 7, wherein the first control loop is configured to compare the current control signal to a signal that represents a total current of all active phases of the multi-phase switching voltage regulator to generate the current error signal.

Example 9. The controller of any of examples 1 through 8, wherein the first control loop comprises a PI (proportional-integral) controller, wherein the first set of coefficients comprises a first proportional coefficient for a proportional term of the PI controller and a first integral coefficient for an integral term of the PI controller, and wherein the second set of coefficients comprises a second proportional coefficient for the proportional term and a second integral coefficient for the integral term.

Example 10. The controller of example 9, wherein the first proportional coefficient is calculated as P/(Vin*n), the first integral coefficient is calculated as I/(Vin*n), the second proportional coefficient is calculated as P/(Vout*n*swp), and the second integral coefficient is calculated as I/(Vout*n*swp), where n is the number of active phases of the multi-phase switching voltage regulator, Vin is an input voltage of the multi-phase switching voltage regulator, Vout is an output voltage of the multi-phase switching voltage regulator, swp is the number of clocks in a switching period, P is a programmed proportional term, and I is a programmed integral term.

Example 11. The controller of any of examples 1 through 10, wherein the first control loop comprises a voltage mode controller, wherein in the first configuration, the voltage mode controller is configured to use the first set of coefficients to generate a pulse width modulation adjustment signal based on a voltage error signal that represents a difference between a reference voltage and an output voltage of the multi-phase switching voltage regulator, wherein in the second configuration, the voltage mode controller is configured to use the second set of coefficients to generate a pulse frequency modulation adjustment signal based on the voltage error signal.

Example 12. The controller of example 11, wherein in the first configuration, the first control loop is configured to modify a feedforward pulse width modulation signal with the pulse width modulation adjustment signal and a current balance adjustment signal generated by the second control loop for each active phase of the multi-phase switching voltage regulator to generate a pulse width modulation signal for controlling each active phase of the multi-phase switching voltage regulator.

Example 13. The controller of example 11 or 12, wherein in the second configuration, the first control loop is configured to modify a feedforward pulse frequency modulation signal with the pulse frequency modulation adjustment signal to generate a pulse frequency modulation signal for controlling each active phase of the multi-phase switching voltage regulator.

Example 14. The controller of example 13, wherein in the second configuration, the second control loop is configured to modify a constant on-time for each active phase of the multi-phase switching voltage regulator based on phase current imbalance observed by the second control loop.

Example 15. The controller of any of examples 1 through 14, wherein the first control loop comprises a PID (proportional-integral-derivative) controller, wherein the first set of coefficients comprises a first proportional coefficient for a proportional term of the PID controller, a first integral coefficient for an integral term of the PID controller, and a first derivative coefficient for a derivative term of the PID controller, and wherein the second set of coefficients comprises a second proportional coefficient for the proportional term of the PID controller, a second integral coefficient for the integral term of the PID controller, and a second derivative coefficient for the derivative term of the PID controller.

Example 16. The controller of example 15, wherein the first proportional coefficient is calculated as P/(Vin*\sqrt{n}), the first integral coefficient is calculated as I/Vin, the first derivative coefficient is calculated as D/(Vin*n), the second proportional coefficient is calculated as P/(Vout*\sqrt{n}*swp), the second integral coefficient is calculated as I/(Vout*swp), and the second derivative coefficient is calculated as D/(Vout*n*swp), where n is the number of active phases of the multi-phase switching voltage regulator, Vin is an input voltage of the multi-phase switching voltage regulator, Vout is an output voltage of the multi-phase switching voltage regulator, swp is the number of clocks in a switching period, P is a programmed proportional term, I is a programmed integral term, and D is a programmed derivative term.

Example 17. A voltage regulator system, comprising: a multi-phase switching voltage regulator; and a controller configured to control the multi-phase switching voltage regulator, the controller comprising: a first control loop having a first set of coefficients for implementing pulse width modulation (PWM) and a second set of coefficients for implementing pulse frequency modulation (PFM); and a second control loop configured to implement phase current balancing for the multi-phase switching voltage regulator, wherein in a first configuration, the first control loop is configured to implement PWM-based control of the multi-phase switching voltage regulator using the first set of coefficients, wherein in a second configuration, the first control loop is configured to implement PFM-based control of the multi-phase switching voltage regulator using the second set of coefficients.

Example 18. The voltage regulator system of example 17, wherein the first control loop comprises: a voltage mode controller configured to generate a current control signal based on a voltage error signal that represents a difference between a reference voltage and an output voltage of the multi-phase switching voltage regulator; and a current mode controller, wherein in the first configuration, the current mode controller is configured to use the first set of coefficients to generate a pulse width modulation adjustment signal based on a current error signal derived from the current control signal, wherein in the second configuration, the current mode controller is configured to use the second set of coefficients to generate a pulse frequency modulation adjustment signal based on the current error signal.

Example 19. The voltage regulator system of example 17 or 18, wherein the first control loop comprises a voltage mode controller, wherein in the first configuration, the voltage mode controller is configured to use the first set of coefficients to generate a pulse width modulation adjustment signal based on a voltage error signal that represents a difference between a reference voltage and an output voltage of the multi-phase switching voltage regulator, wherein in the second configuration, the voltage mode controller is configured to use the second set of coefficients to generate a pulse frequency modulation adjustment signal based on the voltage error signal.

Example 20. The voltage regulator system of any of examples 17 through 19, wherein the first control loop comprises a PID (proportional-integral-derivative) controller, wherein the first set of coefficients comprises a first proportional coefficient for a proportional term of the PI controller, a first integral coefficient for an integral term of the PI controller, and a first derivative coefficient for a derivative term of the PI controller, and wherein the second set of coefficients comprises a second proportional coefficient for the proportional term of the PI controller, a second integral coefficient for the integral term of the PI controller, and a second derivative coefficient for the derivative term of the PI controller.

Terms such as “first”, “second”, and the like, are used to describe various elements, regions, sections, etc, and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to cover all possible conjunctive and disjunctive combinations, unless expressly noted otherwise. For example, the expression “A and/or B” should be interpreted to mean A but not B, B but not A, or both A and B. The expression “at least one of” should be interpreted in the same manner as “and/or”, unless expressly noted otherwise. For example, the expression “at least one of A and B” should be interpreted to mean A but not B, B but not A, or both A and B.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A controller for a multi-phase switching voltage regulator, the controller comprising:
a first control loop having a first set of coefficients for implementing pulse width modulation (PWM) and a second set of coefficients for implementing pulse frequency modulation (PFM); and
a second control loop configured to implement phase current balancing for the multi-phase switching voltage regulator,
wherein in a first configuration, the first control loop is configured to implement PWM-based control of the multi-phase switching voltage regulator using the first set of coefficients,
wherein in a second configuration, the first control loop is configured to implement PFM-based control of the multi-phase switching voltage regulator using the second set of coefficients.

2. The controller of claim 1, wherein the first control loop is programmable in either the first configuration or the second configuration during operation of the multi-phase switching voltage regulator.

3. The controller of claim 1, wherein the first control loop comprises:
a voltage mode controller configured to generate a current control signal based on a voltage error signal that represents a difference between a reference voltage and an output voltage of the multi-phase switching voltage regulator; and
a current mode controller,
wherein in the first configuration, the current mode controller is configured to use the first set of coefficients to generate a pulse width modulation adjustment signal based on a current error signal derived from the current control signal,
wherein in the second configuration, the current mode controller is configured to use the second set of coefficients to generate a pulse frequency modulation adjustment signal based on the current error signal.

4. The controller of claim 3, wherein in the first configuration, the first control loop is configured to modify a feedforward pulse width modulation signal with the pulse width modulation adjustment signal and a current balance adjustment signal generated by the second control loop for each active phase of the multi-phase switching voltage regulator to generate a pulse width modulation signal for controlling each active phase of the multi-phase switching voltage regulator.

5. The controller of claim 3, wherein in the second configuration, the first control loop is configured to modify a feedforward pulse frequency modulation signal with the pulse frequency modulation adjustment signal to generate a pulse frequency modulation signal for controlling each active phase of the multi-phase switching voltage regulator.

6. The controller of claim 5, wherein in the second configuration, the second control loop is configured to modify a constant on-time for each active phase of the multi-phase switching voltage regulator based on phase current imbalance observed by the second control loop.

7. The controller of claim 3, wherein the first control loop is configured to divide the current control signal by a number of active phases of the multi-phase switching voltage regulator to generate a per-phase current control signal, and compare the per-phase current control signal to a signal that represents an average current of all the active phases to generate the current error signal.

8. The controller of claim 3, wherein the first control loop is configured to compare the current control signal to a signal that represents a total current of all active phases of the multi-phase switching voltage regulator to generate the current error signal.

9. The controller of claim 1, wherein the first control loop comprises a PI (proportional-integral) controller, wherein the first set of coefficients comprises a first proportional coefficient for a proportional term of the PI controller and a first integral coefficient for an integral term of the PI controller, and wherein the second set of coefficients comprises a second proportional coefficient for the proportional term and a second integral coefficient for the integral term.

10. The controller of claim 9, wherein the first proportional coefficient is calculated as P/(Vin*n), the first integral coefficient is calculated as I/(Vin*n), the second proportional coefficient is calculated as P/(Vout*n*swp), and the second integral coefficient is calculated as I/(Vout*n*swp), where n is the number of active phases of the multi-phase switching voltage regulator, Vin is an input voltage of the multi-phase switching voltage regulator, Vout is an output voltage of the multi-phase switching voltage regulator, swp is the number of clocks in a switching period, P is a programmed proportional term, and I is a programmed integral term.

11. The controller of claim 1, wherein the first control loop comprises a voltage mode controller, wherein in the first configuration, the voltage mode controller is configured to use the first set of coefficients to generate a pulse width modulation adjustment signal based on a voltage error signal that represents a difference between a reference voltage and an output voltage of the multi-phase switching voltage regulator, wherein in the second configuration, the voltage mode controller is configured to use the second set of coefficients to generate a pulse frequency modulation adjustment signal based on the voltage error signal.

12. The controller of claim 11, wherein in the first configuration, the first control loop is configured to modify a feedforward pulse width modulation signal with the pulse width modulation adjustment signal and a current balance adjustment signal generated by the second control loop for each active phase of the multi-phase switching voltage regulator to generate a pulse width modulation signal for controlling each active phase of the multi-phase switching voltage regulator.

13. The controller of claim 11, wherein in the second configuration, the first control loop is configured to modify a feedforward pulse frequency modulation signal with the pulse frequency modulation adjustment signal to generate a pulse frequency modulation signal for controlling each active phase of the multi-phase switching voltage regulator.

14. The controller of claim 13, wherein in the second configuration, the second control loop is configured to modify a constant on-time for each active phase of the multi-phase switching voltage regulator based on phase current imbalance observed by the second control loop.

15. The controller of claim 1, wherein the first control loop comprises a PID (proportional-integral-derivative) controller, wherein the first set of coefficients comprises a first proportional coefficient for a proportional term of the PID controller, a first integral coefficient for an integral term of the PID controller, and a first derivative coefficient for a derivative term of the PID controller, and wherein the second set of coefficients comprises a second proportional coefficient for the proportional term of the PID controller, a second integral coefficient for the integral term of the PID controller, and a second derivative coefficient for the derivative term of the PID controller.

16. The controller of claim 15, wherein the first proportional coefficient is calculated as P/(Vin*\sqrt{n}), the first integral coefficient is calculated as I/Vin, the first derivative coefficient is calculated as D/(Vin*n), the second proportional coefficient is calculated as P/(Vout*\sqrt{n}*swp), the second integral coefficient is calculated as I/(Vout*swp), and the second derivative coefficient is calculated as D/(Vout*n*swp), where n is the number of active phases of the multi-phase switching voltage regulator, Vin is an input voltage of the multi-phase switching voltage regulator, Vout is an output voltage of the multi-phase switching voltage regulator, swp is the number of clocks in a switching period, P is a programmed proportional term, I is a programmed integral term, and D is a programmed derivative term.

17. A voltage regulator system, comprising:
a multi-phase switching voltage regulator; and
a controller configured to control the multi-phase switching voltage regulator, the controller comprising:
a first control loop having a first set of coefficients for implementing pulse width modulation (PWM) and a second set of coefficients for implementing pulse frequency modulation (PFM); and
a second control loop configured to implement phase current balancing for the multi-phase switching voltage regulator,
wherein in a first configuration, the first control loop is configured to implement PWM-based control of the multi-phase switching voltage regulator using the first set of coefficients,
wherein in a second configuration, the first control loop is configured to implement PFM-based control of the multi-phase switching voltage regulator using the second set of coefficients.

18. The voltage regulator system of claim 17, wherein the first control loop comprises:
a voltage mode controller configured to generate a current control signal based on a voltage error signal that represents a difference between a reference voltage and an output voltage of the multi-phase switching voltage regulator; and
a current mode controller,
wherein in the first configuration, the current mode controller is configured to use the first set of coefficients to generate a pulse width modulation adjustment signal based on a current error signal derived from the current control signal,
wherein in the second configuration, the current mode controller is configured to use the second set of coefficients to generate a pulse frequency modulation adjustment signal based on the current error signal.

19. The voltage regulator system of claim 17, wherein the first control loop comprises a voltage mode controller, wherein in the first configuration, the voltage mode controller is configured to use the first set of coefficients to generate a pulse width modulation adjustment signal based on a voltage error signal that represents a difference between a reference voltage and an output voltage of the multi-phase switching voltage regulator, wherein in the second configuration, the voltage mode controller is configured to use the second set of coefficients to generate a pulse frequency modulation adjustment signal based on the voltage error signal.

20. The voltage regulator system of claim 17, wherein the first control loop comprises a PID (proportional-integral-derivative) controller, wherein the first set of coefficients comprises a first proportional coefficient for a proportional term of the PI controller, a first integral coefficient for an integral term of the PI controller, and a first derivative coefficient for a derivative term of the PI controller, and wherein the second set of coefficients comprises a second proportional coefficient for the proportional term of the PI controller, a second integral coefficient for the integral term of the PI controller, and a second derivative coefficient for the derivative term of the PI controller.
